(19) United States
(12) Patent Application Publication
(10) Pub. No.: US 2007/0223025 A1
(43) Pub. Date: Sep. 27, 2007

(54) Printing Apparatus and Method, Computer-Readable Medium, and Computer Data Signal

(75) Inventor: Takashi Hashizume, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/563,752

(22) Filed: Nov. 28, 2006

(30) Foreign Application Priority Data
Mar. 27, 2006 (JP) 2006-084790

(51) Int. Cl. G06F 3/12

(52) U.S. Cl. 358/1.13

(57) ABSTRACT

A printing apparatus includes a print request reception section that receives a print request including PDL data; a data conversion section that converts the received PDL data into an electronic document file; and an electronic document storage section that stores the converted electronic document file into a memory device.

### BACKGROUND

### PRIORITY INFORMATION

This application claims priority to Japanese Patent Application No. 2006-084790, filed on Mar. 27, 2006.

### TECHNICAL FIELD

The present invention relates to a printing apparatus and method, a computer-readable medium, and a computer data signal.

### RELATED ART

In recent years, as part of information management, there is required a function to enable later confirmation of content print-outputted from a printing apparatus. In order to realize this, there has been conceivable a method in which image data created at the time of printing are stored as a log. However, not only does the data capacity of the image data become large, but retrieval performance also becomes low.

### SUMMARY

According to one aspect of the present invention, there is provided a printing apparatus having: a print request reception section that receives a print request including PDL data; a data conversion section that converts the received PDL data into an electronic document file; and an electronic document storage section that stores the converted electronic document file into a memory device.

### BRIEF DESCRIPTION OF THE DRAWINGS

Exemplary embodiments of the present invention will be described in detail based on the following figures, wherein:

FIG. 1 is a block diagram showing the overall structure of a printing system including a printing apparatus according to a first exemplary embodiment;

FIG. 2 is a flowchart showing an operation procedure performed at the time of PDL data printing by the printing apparatus according to the first exemplary embodiment;

FIG. 3 is a block diagram showing the overall structure of a printing system including a printing apparatus according to a second exemplary embodiment; and

FIG. 4 is a flowchart showing an operation procedure performed at the time of PDL data printing by the printing apparatus according to the second exemplary embodiment.

### DETAILED DESCRIPTION

Hereinafter, exemplary embodiments of the invention will be described with reference to the drawings.

### First Exemplary Embodiment

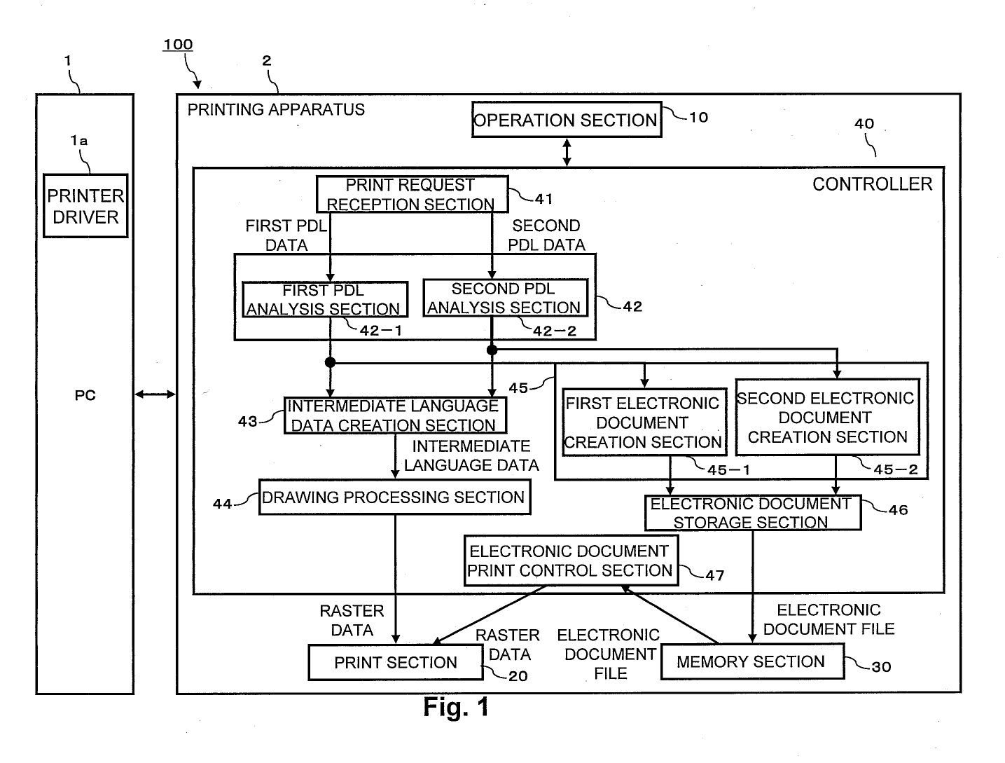

FIG. 1 is a block diagram showing the overall structure of a printing system 100 including a printing apparatus 2 according to a first exemplary embodiment. In FIG. 1, the printing system 100 includes a PC 1 and the printing apparatus 2. The PC 1 and the printing apparatus 2 are connected to each other through a network such as a LAN (Local Area Network) However, the PC 1 and the printing apparatus 2 may be directly connected to each other. In addition, needless to say, multiple PCs may be connected to the printing apparatus 2.

The PC 1 is a client apparatus that sends a print request including PDL (Page Description Language) data to the printing apparatus 2. Here, the processing of sending the print request is performed by a printer driver la installed in the PC 1. The PDL data are described in printer control codes for creating a page image, and generally cannot be browsed by a personal computer (PC) or the like. Moreover, in general, as compared with data in an electronic document format such as PDF (Portable Document format), the PDL data have a large volume.

The printing apparatus 2 is a device that receives a print request including the PDL data from the PC 1, and prints the PDL data. In FIG. 1, the printing apparatus 2 includes an operation section 10, a print section 20, a memory section 30, and a controller 40.

The operation section 10 is a user interface that presents various information to the user and receives an operation input from the user, and is, for example, a touch panel display.

The print section 20 is a device, a so-called IOT (Image Output Terminal) , that receives raster data from the controller 40 and prints an image on a print medium, such as paper, by a suitable printing system, such as an electrophotographic system, on the basis of the raster data.

The memory section 30 is a nonvolatile memory device for storing data, and is, for example, a hard disk device or the like.

The controller 40 controls the entire printing apparatus 2. In this exemplary embodiment, the controller 40 is a circuit board on which a CPU (Central Processing Unit), ROM (Read Only Memory), a main memory, NVRAM (Non Volatile RAM) and the like are mounted, and its function is realized in such a manner that a program stored in a storage medium such as the ROM is read into a memory and is executed by the CPU. However, the function of the controller 40 may be realized by a hardware circuit such as an ASIC (Application Specific Integrated Circuit). The controller 40 includes, as function blocks, a print request reception section 41, a PDL analysis section 42, an intermediate language data creation section 43, a drawing processing section 44, an electronic document creation section 45, an electronic document storage section 46, and an electronic document print control section 47.

The print request reception section 41 receives the print request including the PDL data. Here, as the PDL, for example, “PostScript,” TIPCL,” “ART EX,” and the like can be named.

The PDL analysis section 42 analyzes the PDL data received by the print request reception section 41. In this exemplary embodiment, the printing apparatus 2 supports two kinds of PDLs, and the PDL analysis section 42 includes a first PDL analysis section 42-1 for analyzing PDL data described in first PDL (hereinafter referred to as “first PDL data”), and a second PDL analysis section 42-2 for analyzing PDL data described in second PDL (hereinafter referred to as “second PDL data”). However, the printing apparatus 2 may support one kind of PDL, or may support three or more kinds of PDLs.

The intermediate language data creation section 43 creates intermediate language data described in a specified intermediate language, on the basis of the analysis result of the PDL analysis section 42.

The drawing processing section 44 creates raster data based on the intermediate language data created by the intermediate language data creation section 43, and outputs the raster data to the print section 20.

The electronic document creation section 45 creates an electronic document file as a file in electronic document format on the basis of the analysis result of the PDL analysis section 42. That is, the PDL analysis section 42 and the electronic document creation section 45 convert the PDL data into the electronic document file. Specifically, a command of the PDL is analyzed and is replaced with a command of the electronic document. In this exemplary embodiment, the electronic document creation section 45 includes a first electronic document creation section 45-1 for creating an electronic document file based on the analysis result of the first PDL analysis section 42-1 and a second electronic document creation section 45-2 for creating an electronic document file based on the analysis result of the second PDL analysis section 42-2. From the viewpoint that character string retrieval is enabled, with respect to a character represented by a character code in the PDL data, the electronic document creation section 45 puts into the electronic document file the character in character code format. Moreover, in this exemplary embodiment, the electronic document creation section 45 creates a PDF (Portable Document Format) file as the electronic document file. However, the electronic document file may be a file in a different electronic document format such as DocuWorks (registered trademark). Different from the PDL data, the file in the electronic document format can be browsed on the PC. In addition, in general, as compared with the PDL data, the data volume of the file in the electronic document format is small.

The electronic document storage section 46 stores into the memory section 30 the electronic document file created by the electronic document creation section 45. Specifically, the electronic document storage section 46 correlates the electronic document file with a user requesting printing, a printing date, and the like, and stores this information as a log into the memory section 30. In this exemplary embodiment, from the viewpoint that the correctness of the electronic document file or log content is guaranteed, the electronic document storage section 46 adds an electronic signature to the electronic document file or the log and stores it.

The electronic document print control section 47 causes the print section 20 to print the electronic document file stored in the memory section 30 in accordance with the instruction input to the operation section 10 or the instruction input from the PC 1.

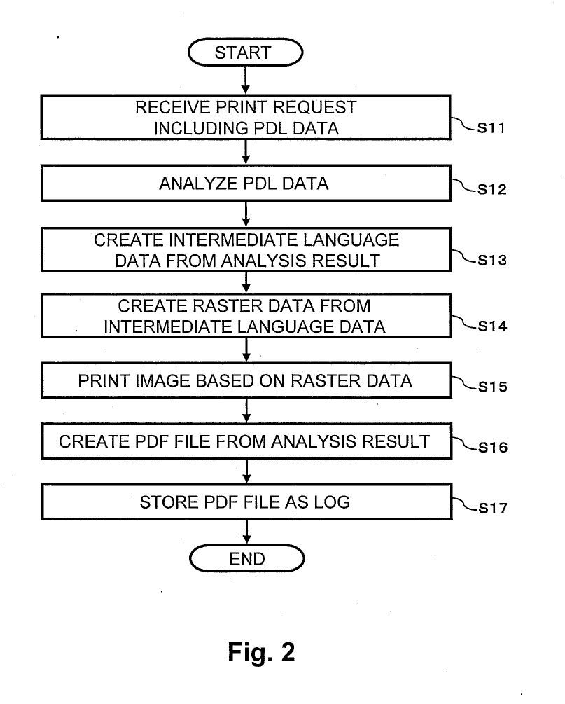

FIG. 2 is a flowchart showing an operation procedure at the time of PDL data printing of the printing apparatus 2 according to the first exemplary embodiment. Hereinafter, the operation of the printing system 100 having the above structure at the time of PDL data printing will be specifically described with reference to FIG. 2.

When receiving from the user the input of the print instruction specifying the electronic file to be printed, the PC 1 of the client converts the specified electronic file into the PDL data by means of the printer driver la, and transmits to the printing apparatus 2 a print request including the PDL data. Incidentally, here, the PDL data are assumed to be the first PDL data.

In the printing apparatus 2, upon receiving the print request including the first PDL data from the PC 1, the print request reception section 41 delivers the first PDL data to the first PDL analysis section 42-1 (S11).

Upon receiving the first PDL data from the print request reception section 41, the first PDL analysis section 42-1 analyzes the first PDL data, and delivers the analysis result to the intermediate language creation section 43 and the first electronic document creation section 45-1 (S12).

The intermediate language data creation section 43 creates the intermediate language data from the analysis result of the first PDL analysis section 42-1, and delivers the intermediate language data to the drawing processing section 44 (S13).

Upon receiving the intermediate language data from the intermediate language data creation section 43, the drawing processing section 44 creates raster data from the intermediate language data and delivers the data to the print section 20 (S14).

The print section 20 prints an image on a recording medium, such as paper, on the basis of the raster data received from the drawing processing section 44 (S15).

The first electronic document creation section 45-1 creates the PDF file from the analysis result of the first PDL analysis section 42-1, and delivers the PDF file to the electronic document storage section 46 (S16).

Upon receiving the PDF file from the first electronic document creation section 45-1, the electronic document storage section 46 creates log information including the PDF file, adds an electronic signature to the log information, and stores the log information into the memory section 30 (S17) Specifically, the electronic document storage section 46 creates the log information including the PDF file, identification information of the user or the PC relating to the print request, and the print request date; adds the electronic signature to the log information; and stores the log information with the electronic signature into the memory section 30.

Next, the operation of the printing system 100 at the time of use of the electronic document file is divided into a case where it is used in the printing apparatus 2 and a case where it is used from the PC 1, and will be specifically described.

[Case where Used in the Printing Apparatus]

In the case where the user desires to browse a document printed in the past, he/she operates the operation section 10 to input a log browse request. Upon receiving the user operation, the controller 40 reads the log information from the memory section 30 and list-displays it on the screen of the operation section 10.

In the case where the user desires to perform character string retrieval on a document printed in the past, he/she specifies the retrieval character string by the operation section 10, and inputs the retrieval instruction. Upon receiving the user operation, the controller 40 retrieves, from the log information stored in the memory section 30, log information in which the PDF file includes the retrieval character string, and list-displays the retrieved log information on the screen of the operation section 10.

In the case where the user desires to print-output a document printed in the past, he/she specifies the desired PDF file on the list screen displayed in accordance with the log browse request or on the list screen displayed in accordance with the retrieval instruction, and inputs the print instruction. Upon receiving the user operation, the electronic document print control section 47 of the controller 40 reads the specified PDF file from the memory section 30. The electronic document print control section 47 analyzes the PDF file to create intermediate language data, creates raster data from the intermediate language data, and outputs the raster data to the print section 20. The print section 20 print-outputs an image based on the raster data to a recording medium such as paper.

As stated above, with respect to the document printed in the past, the user can perform the browsing, retrieval, and printing by operating the operation section 10 of the printing apparatus 2.

(Case where Used from the PC)

In the case where the user desires to browse a document printed in the past, he/she operates the PC 1 to send a log browse request to the printing apparatus 2. Upon receiving the request, the controller 40 of the printing apparatus 2 reads the log information from the memory section 30, and list-displays it on the screen of the PC 1.

In the case where the user desires to perform character string retrieval on a document printed in the past, he/she operates the PC 1 to send to the printing apparatus 2 a retrieval instruction including the specification of a retrieval character string. Upon receiving the instruction, the controller 40 of the printing apparatus 2 retrieves, from the log information stored in the memory section 30, log information in which the PDF file includes the retrieval character string, and list-displays the retrieved log information on the screen of the PC 1.

In the case where the user desires to print-output a document printed in the past, he/she specifies the desired PDF file on the list screen displayed in accordance with the log browse request or on the list screen displayed in accordance with the retrieval instruction, and sends a print instruction to the printing apparatus 20. Upon receiving the instruction, the electronic document print control section 47 of the controller 40 of the printing apparatus 2 reads the specified PDF file from the memory section 30, and causes the print section 20 to print the PDF file.

In the case where the user desires to capture log information into the PC 1, he/she operates the PC 1 to send a log information acquisition request to the printing apparatus 2. Upon receiving the request, the controller 40 of the printing apparatus 2 reads the log information from the memory section 30 and sends it to the PC 1.

As stated above, with respect to the document printed in the past, the user can perform the browsing, retrieval, printing, and capture into the PC 1 by operating the PC 1.

Although the exchange between the PC 1 and the printing apparatus 2 can be realized by a suitable method, for example, it can be realized by a Web browser on the PC 1 and a Web server on the printing apparatus 2.

Incidentally, needless to say, the PC using the log information is not limited to the PC 1, but may be another PC.

### Second Exemplary Embodiment

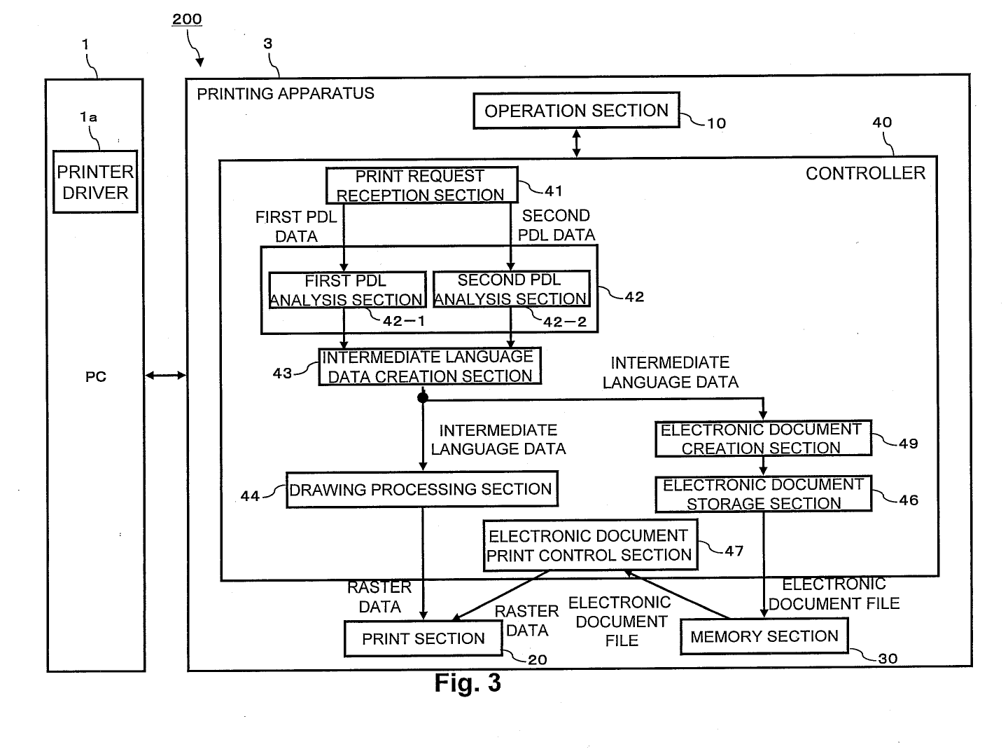

FIG. 3 is a block diagram showing the overall structure of a printing system 200 including a printing apparatus 3 according to a second exemplary embodiment. Although the printing system 200 is almost identical with the printing system 100, the printing apparatus 3 analyzes PDL data to create intermediate language data, and converts the data into an electronic document file. Hereinafter, although the printing system 200 will be described, portions common to the printing system 100 are denoted by the same reference numerals and their repeated description will be omitted.

As shown in FIG. 3, in this exemplary embodiment, a controller 40 includes an electronic document creation section 49 instead of the electronic document creation section 45. The electronic document creation section 49 creates an electronic document file based on intermediate language data created by an intermediate language data creation section 43. That is, a PDL analysis section 42, the intermediate language data creation section 43, and the electronic document creation section 49 analyze PDL data to create the intermediate language data, and convert the intermediate language data into the electronic document file.

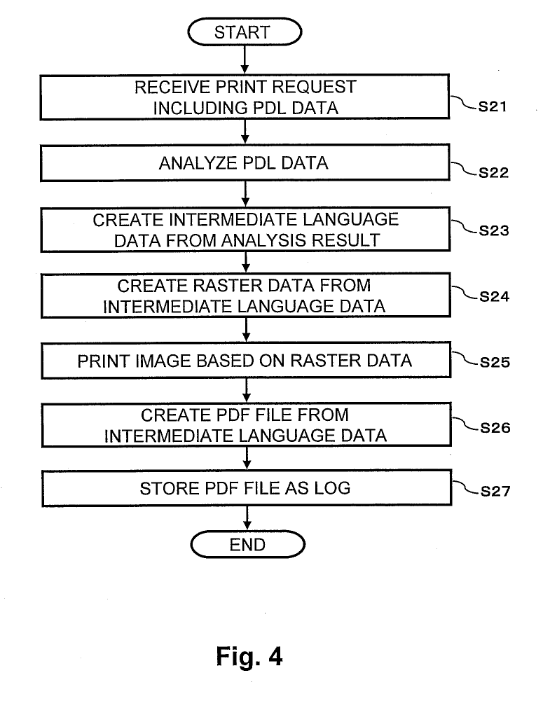

FIG. 4 is a flowchart showing an operation procedure of the printing apparatus 3 according to the second exemplary embodiment at the time of PDL data printing. Hereinafter, the operation of the printing system 200 having the above structure at the time of PDL data printing will be specifically described with reference to FIG. 4.

When receiving a print request including first PDL data from a PC 1, a print request reception section 41 delivers the first PDL data to a first PDL analysis section 42-1 (S21).

The first PDL analysis section 42-1 analyzes the first PDL data, and delivers the analysis result to the intermediate language data creation section 43 (S22).

The intermediate language data creation section 43 creates the intermediate language data from the analysis result, and delivers the intermediate language data to a drawing processing section 44 and the electronic document creation section 49 (S23).

The drawing processing section 44 creates raster data from the intermediate language data, and delivers the raster data to a print section 20 (S24).

The print section 20 prints an image on a recording medium, such as paper, on the basis of the raster data (S25).

The electronic document creation section 49 creates a PDF file from the intermediate language data received from the intermediate language data creation section 43, and delivers the PDF file to an electronic document storage section 46 (S26) Upon receiving the PDF file from the electronic document creation section 49, the electronic document storage section 46 stores into a memory section 30 log information including the PDF file and having an electronic signature (S27).

The foregoing description of the exemplary embodiments of the present invention has been provided for the purpose of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A printing apparatus comprising:
a print request reception section that receives a print request including PDL data;
a data conversion section that converts the received PDL data into an electronic document file; and
an electronic document storage section that stores the converted electronic document file into a memory device.

2. The printing apparatus according to claim 1, wherein, with respect to a character represented by a character code in the PDL data, the data conversion section puts the character into the electronic document file in character code format.

3. The printing apparatus according to claim 1, wherein the data conversion section directly converts the PDL data into the electronic document file.

4. The printing apparatus according to claim 1, wherein the data conversion section converts the PDL data into intermediate language data, and converts the intermediate language data into the electronic document file.

5. The printing apparatus according to claim 1, wherein the electronic document storage section adds an electronic signature to the electronic document file and stores it.

6. The printing apparatus according to claim 1, further comprising a PDL data print section that prints the received PDL data.

7. The printing apparatus according to claim 1, further comprising an electronic document print section that prints the stored electronic document file.

8. The printing apparatus according to claim 7, wherein the electronic document print section prints the electronic document file in accordance with an instruction inputted to an operation section of the printing apparatus.

9. The printing apparatus according to claim 1, wherein the electronic document file is a file in PDF format.

10. A method for storing a document whose printing is requested, comprising:
receiving a print request including PDL data;
converting the received PDL data into an electronic document file; and
storing the converted electronic document file into a memory device.

11. The method according to claim 10, wherein a character represented by a character code in the PDL data is put into the electronic document file in character code format.

12. The method according to claim 10, wherein the PDL data are directly converted into the electronic document file.

13. A computer readable medium storing a program causing a computer to execute a process for storing a document whose printing is requested, the process comprising:
receiving a print request including PDL data;
converting the received PDL data into an electronic document file; and
storing the converted electronic document file into a memory device.

14. The computer readable medium according to claim 13, wherein a character represented by a character code in the PDL data is put into the electronic document file in character code format.

15. The computer readable medium according to claim 13, wherein the PDL data are directly converted into the electronic document file.

16. A computer data signal embodied in a carrier wave for enabling a computer to perform a process for storing a document whose printing is requested, the process comprising: receiving a print request including PDL data;
converting the received PDL data into an electronic document file; and
storing the converted electronic document file into a memory device.

17. The computer data signal according to claim 16, wherein a character represented by a character code in the PDL data is put into the electronic document file in character code format.

18. The computer data signal according to claim 16, wherein the PDL data are directly converted into the electronic document file.
